(19) United States
(12) Patent Application Publication
(10) Pub. No.: US 2016/0366910 A1
(43) Pub. Date: Dec. 22, 2016

(54) Dog Treat

(71) Applicant: David Allen Kirchinger, Saint Petersburg, FL (US)

(72) Inventor: David Allen Kirchinger, Saint Petersburg, FL (US)

(21) Appl. No.: 15/186,989

(22) Filed: Jun. 20, 2016

Related U.S. Application Data
(60) Provisional application No. 62/181,924, filed on Jun. 19, 2015.

(51) Int. Cl. A23K 40/20; A23K 10/30; A23K 50/40; A23K 10/20

(52) U.S. Cl. CPC A23K 40/20; A23K 10/20; A23K 10/30; A23K 50/40

(57) ABSTRACT

A waffle dog treat to be consumed by dogs is formed by cooking a dog treat waffle batter in a waffle iron. The dog treat waffle batter is created by mixing a quantity of flour, a quantity of water, a quantity of baking soda, and a quantity of flavoring. The quantity of flour, the quantity of water, and the quantity of baking soda are the base ingredients and can be used to make a non-flavored treat. The quantity of flavoring is a supplemental ingredient(s) that is used to impart a flavor within the waffle dog treat that is appealing to dogs. The dog treat waffle batter is heated at a predetermined heating temperature for a predetermined heating time within the waffle iron, wherein the waffle iron gives shape to the waffle dog treat. Once cooked, the waffle dog treat is removed and allowed to cool for a predetermined cooling time.

The current application claims a priority to the U.S. Provisional Patent application Ser. No. 62/181,924 filed on Jun. 19, 2015.

### FIELD OF THE INVENTION

The present invention relates generally to food for pets. More specifically, the present invention is a waffle that is intended to be consumed by dogs.

### BACKGROUND OF THE INVENTION

Dog treats have historically been given to dogs as a reward, to help work out the dogs' jaw muscles, and to keep the dogs' teeth clean. There are numerous brands of dog treats out in the market that many dog owners purchase, but there are also dog owners that make their own dog treats. One of the main aspects of a good dog treat is the hardness of the dog treat. Another aspect is the shape of the dog treat, as different shapes may be easier or harder for a dog to handle and may better assist in cleaning a dog's teeth. A waffle shape, having many nooks, would be an ideal shape for a dog treat, as the dog treat would be easy for a dog to grasp and would have many surfaces to help clean the dog's teeth. Unfortunately, conventional waffles tend to be crispy on the outside at best while being way too soft on the inside to qualify as a legitimate dog treat. The present invention solves this issue by providing a new dog treat that is a legitimate waffle yet has the hardness of a good dog treat.

Therefore it is the object of the present invention to provide a dog treat waffle batter and a method for making waffle dog treats. The dog treat waffle batter is formed from a quantity of flour, a quantity of water, a quantity of baking soda, and a quantity of flavoring. The dog treat waffle batter is first mixed and then poured into a waffle iron, wherein the waffle iron defines the shape and size of the waffle dog treats. The dog treat waffle batter is cooked in the waffle iron at a predetermined heating temperature for a predetermined heating time, in order to harden the dog treat waffle batter into a waffle dog treat. The waffle dog treat is then removed from the waffle iron and is placed in a cooling environment, wherein the waffle dog treat is further dehydrated and allowed to harden all the way through.

### BRIEF DESCRIPTION OF THE DRAWINGS

FIG. 1 is a block diagram depicting the ingredients used to make the waffle dog treat.

FIG. 2 is a block diagram depicting the ratio of the ingredients in the dog treat waffle batter.

FIG. 3 is a block diagram depicting various ingredients that can be included in the quantity of flavoring.

FIG. 4 is a flowchart depicting the steps for forming the waffle dog treat from the quantity of flour, the quantity of water, the quantity of baking soda, and the quantity of flavoring.

### DETAIL DESCRIPTIONS OF THE INVENTION

All illustrations of the drawings are for the purpose of describing selected versions of the present invention and are not intended to limit the scope of the present invention.

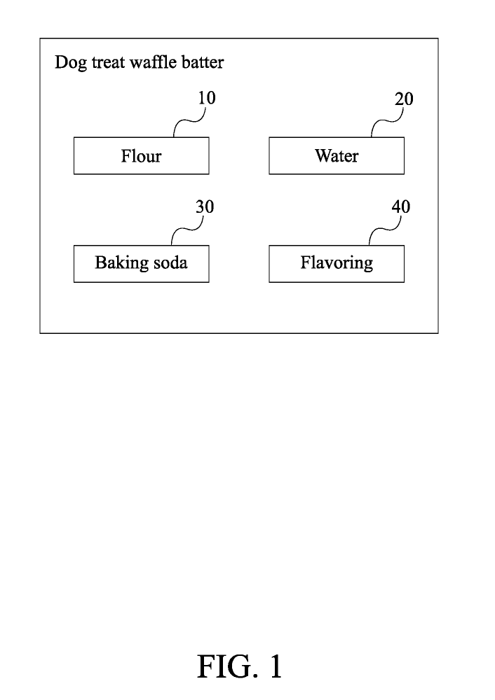

The present invention is a waffle dog treat intended to be consumed by dogs. The waffle dog treat stays dry and hard all the way through, providing the perfect treat for dogs to consume. In reference to FIG. 1, the waffle dog treat is created using a quantity of flour 10, a quantity of water 20, a quantity of baking soda 30, and a quantity of flavoring 40. In the preferred embodiment of the present invention, the quantity of flour 10 is all purpose flour. However, it is possible for the quantity of flour 10 to be other types of flour in other embodiments of the present invention.

In order to make the waffle dog treat, a dog treat waffle batter must first be formed by combining each of the ingredients. The quantity of flour 10, the quantity of water 20, the quantity of baking soda 30, and the quantity of flavoring 40 are combined and mixed together to form the dog treat waffle batter, as depicted in FIG. 1. The quantity of flour 10 acts as a binder to thicken the mixture of the dog treat waffle batter, while the quantity of baking soda 30 helps the dog treat waffle batter to rise. Meanwhile, the quantity of flavoring 40 is utilized to enhance the taste of the waffle dog treat.

The quantity of flour 10, the quantity of water 20, and the quantity of baking soda 30 are base ingredients for the dog treat waffle batter. Using only the base ingredients it is possible to make a non-flavored dog treat, however, it is desirable to have some flavoring in order to encourage dogs to eat the waffle dog treat. As such, the quantity of flavoring 40 is a supplemental ingredient that is used to enhance the flavor of the waffle dog treat. The quantity of flavoring 40 can include a single ingredient or multiple ingredients depending on the embodiment of the present invention.

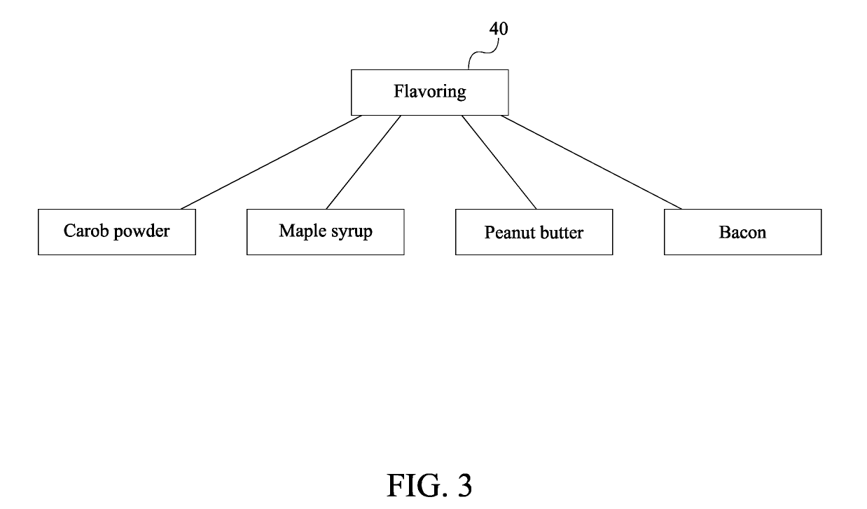

In reference to FIG. 3, in one embodiment of the present invention, the quantity of flavoring 40 comprises maple syrup and carob powder. In another embodiment of the present invention, the quantity of flavoring 40 comprises peanut butter. In yet another embodiment of the present invention, the quantity of flavoring 40 comprises bacon. Furthermore, the quantity of flavoring 40 can include any combination of the maple syrup, the carob powder, the peanut butter, and the bacon in other embodiments. It is also possible for the quantity of flavoring 40 to include additional flavors not explicitly listed but that would be desirable by dogs.

Each of the base ingredients and the supplemental ingredient are combined at specific ratio in order to achieve the waffle dog treat. In the preferred embodiment of the present invention, the quantity of flour 10 is 2 cups of flour, the quantity of water 20 is 2 cups of water, and the quantity of baking soda 30 is 1 tablespoon of baking soda. Furthermore, the quantity of flavoring 40 contains two ingredients; the quantity of flavoring 40 being 2 tablespoons of maple syrup and 1 tablespoon of carob powder.

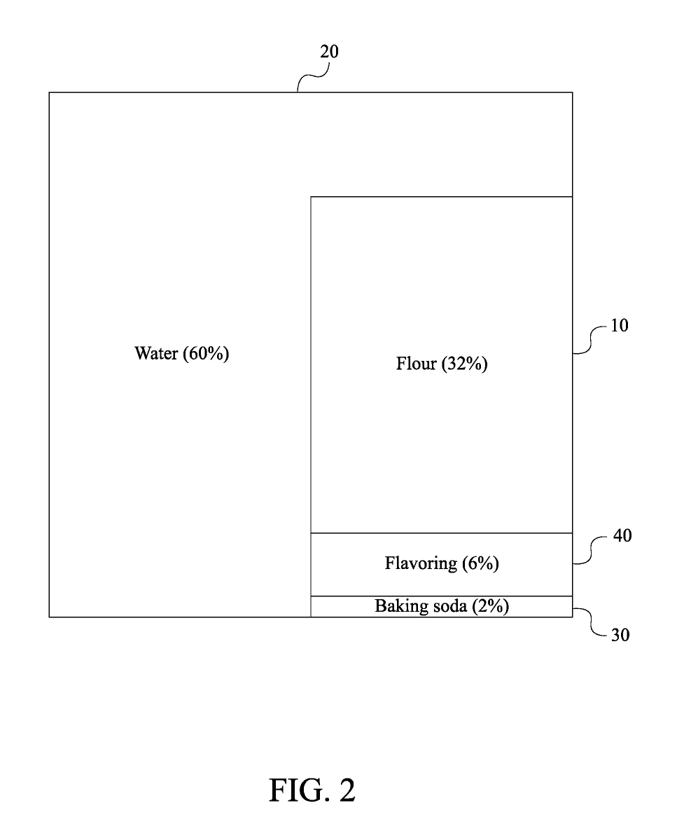

In reference to FIG. 2, the ratio of ingredients previously mentioned can also be converted to a weight distribution of each ingredient within the dog treat waffle batter. Converting the volume measurements to weight measurements, the quantity of flour 10 is approximately 32% of the weight of the dog treat waffle batter. The quantity of water 20 is approximately 60% of the weight of the dog treat waffle batter. The quantity of baking soda 30 is approximately 2% of the weight of the dog treat waffle batter. The quantity of flavoring 40 is approximately 6% of the weight of the dog treat waffle batter.

The deciding factor in the weight distribution ratios is the quantity of flavoring 40 that is used, as different ingredients may have different densities and may require different amounts. However, the ratio of the quantity of flour 10, the quantity of water 20, and the quantity of baking soda 30 in relation to one another is largely unchanged from one embodiment to the next. The weight ratios for a base ingredient mixture consisting of the base ingredients is as follows: the quantity of flour 10 being 34%, by weight, of the base ingredient mixture; the quantity of water 20 being 64%, by weight, of the base ingredient mixture; and the quantity of baking soda 30 being 2%, by weight, of the base ingredient mixture.

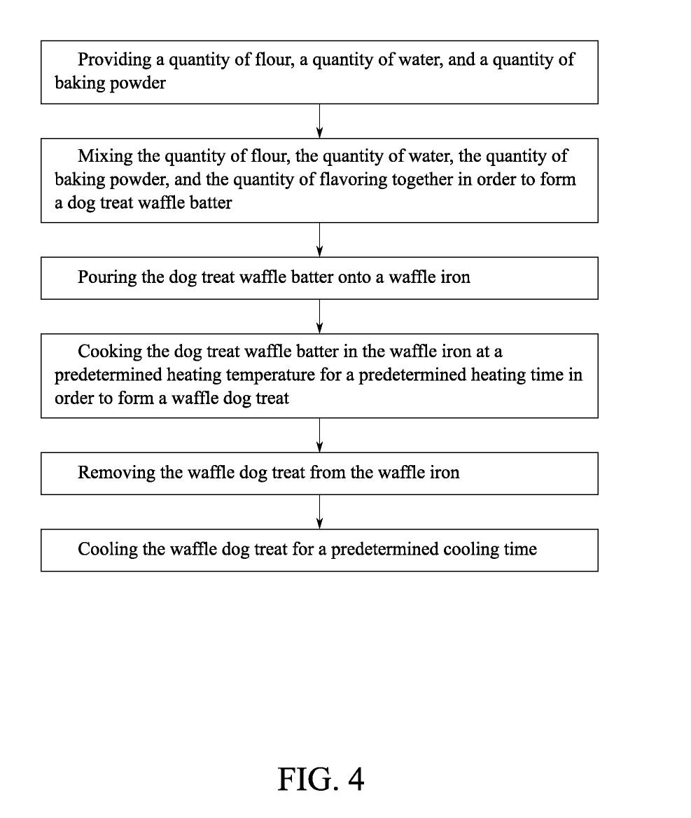

In reference to FIG. 4, in order to make the waffle dog treat, the quantity of flour 10, the quantity of water 20, the quantity of baking soda 30, and the quantity of flavoring 40 are first mixed together in order to form the dog treat waffle batter. The quantity of flour 10, the quantity of water 20, the quantity of baking soda 30, and the quantity of flavoring 40 should be mixed until each of the ingredients is sufficiently blended together and the dog treat waffle batter has a sufficient thickness. Any traditional mixing tools can be utilized in mixing the quantity of flour 10, the quantity of water 20, the quantity of baking soda 30, and the quantity of flavoring 40.

In further reference to FIG. 4, once the dog treat waffle batter has been thoroughly mixed, the dog treat waffle batter is poured into a waffle iron. The waffle iron is used to heat the dog treat waffle batter, transforming the liquid mixture into a solid form. Furthermore, the waffle iron defines the shape of the waffle dog treat that is produced from the cooking of the dog treat waffle batter. The waffle iron defines the size of the nooks in the waffle dog treat, the perimetric shape of the waffle dog treat (e.g. circular, rectangular), the thickness of the waffle dog treat, and the overall size of the waffle dog treat. Depending on the embodiment of the present invention, the waffle iron can be configured to produce a single treat or multiple treats.

In yet further reference to FIG. 4, after the dog treat waffle batter is poured into the waffle iron, the waffle iron is turned on in order to heat the dog treat waffle batter. The dog treat waffle batter is cooked in the waffle iron at a predetermined heating temperature for a predetermined heating time in order to form the waffle dog treat. Typically, the predetermined heating temperature is between 325 degrees and 350 degrees, while the predetermined heating time is approximately 5-7 minutes. However, it is possible for the predetermined heating temperature and the predetermined heating time to vary outside of the given ranges, depending on the embodiment of the present invention and the manufacturing needs.

As the dog treat waffle batter is heated by the waffle iron, the dog treat waffle batter solidifies into the waffle dog treat. After the dog treat waffle batter has been cooked at the predetermined heating temperature for the predetermined heating time, the waffle dog treat is removed from the waffle iron, as depicted in FIG. 4. The heating of the dog treat waffle batter within the waffle iron acts as a first step in a dehydration process that is carried out in order to solidify the dog treat waffle batter into the waffle dog treat. The second step of the dehydration process is carried out once the waffle dog treat has been removed from the waffle iron.

Further referencing FIG. 4, once removed from the waffle iron, the waffle dog treat is cooled in order to further dehydrate and harden the waffle dog treat. Similar to heating the dog treat waffle batter, the waffle dog treat is cooled at a predetermined cooling temperature for a predetermined cooling time. In the preferred embodiment of the present invention, the waffle dog treat is cooled in a forced air movement system (e.g. a fan cooled unit), wherein the predetermined cooling time is approximately 6-8 hours. The predetermined cooling time of 6-8 hours ensures that the waffle dog treat stays dry and hard all the way through. In other embodiments of the present invention, different cooling units/environments/processes may be utilized, depending on the manufacturing and storage needs.

Although the invention has been explained in relation to its preferred embodiment, it is to be understood that many other possible modifications and variations can be made without departing from the spirit and scope of the invention as hereinafter claimed.

What is claimed is:

1. A dog treat waffle batter comprises:
a quantity of flour;
a quantity of water;
a quantity of baking soda;
a quantity of flavoring;
the quantity of flour being approximately 32% weight of the dog treat waffle batter;
the quantity of water being approximately 60% weight of the dog treat waffle batter;
the quantity of baking soda being approximately 2% weight of the dog treat waffle batter; and
the quantity of flavoring being approximately 6% weight of the dog treat waffle batter.

2. The dog treat waffle batter as claimed in claim 1, wherein the quantity of flour, the quantity of water, and the quantity of baking soda are base ingredients for the dog treat waffle batter.

3. The dog treat waffle batter as claimed in claim 1, wherein the quantity of flavoring is a supplemental ingredient for the dog treat waffle batter.

4. The dog treat waffle batter as claimed in claim 1, wherein the quantity of flavoring comprises maple syrup.

5. The dog treat waffle batter as claimed in claim 1, wherein the quantity of flavoring comprises carob powder.

6. The dog treat waffle batter as claimed in claim 1, wherein the quantity of flavoring comprises peanut butter.

7. The dog treat waffle batter as claimed in claim 1, wherein the quantity of flavoring comprises bacon.

8. A method for making waffle dog treats, the method comprises the steps of:
providing a quantity of flour, a quantity of water, and a quantity of baking soda;
mixing the quantity of flour, the quantity of water, and the quantity of baking soda together in order to form a dog treat waffle batter;
pouring the dog treat waffle batter onto a waffle iron;
cooking the dog treat waffle batter in the waffle iron at a predetermined heating temperature for a predetermined heating time in order to form a waffle dog treat;
removing the waffle dog treat from the waffle iron; and
cooling the waffle dog treat for a predetermined cooling time.

9. The method for making waffle dog treats, the method as claimed in claim 1 further comprises the steps of:
providing a quantity of flavoring; and
mixing the quantity of flavoring with the quantity of flour, the quantity of water, and the quantity of baking soda in order to form the dog treat waffle batter.

10. The method for making waffle dog treats, the method as claimed in claim 9, wherein the quantity of flavoring comprises carob powder.

11. The method for making waffle dog treats, the method as claimed in claim 9, wherein the quantity of flavoring comprises maple syrup.

12. The method for making waffle dog treats, the method as claimed in claim 9, wherein the quantity of flavoring comprises peanut butter.

13. The method for making waffle dog treats, the method as claimed in claim 9, wherein the quantity of flavoring comprises bacon.
